(19) United States
(12) Patent Application Publication
(10) Pub. No.: US 2010/0175427 A1
(43) Pub. Date: Jul. 15, 2010

(54) GLASS MELTING FURNACE AND METHOD FOR MELTING GLASSES

(76) Inventor: Helmut Sorg, Glattbach (DE)

Correspondence Address: GREER, BURNS & CRAIN, 300 S WACKER DR, 25TH FLOOR, CHICAGO, IL, 60606, US

(21) Appl. No.: 12/161,968

(22) PCT Filed: Apr. 25, 2008
(86) PCT No.: PCT/EP08/03340

§ 371 Date: Jul. 24, 2008

(30) Foreign Application Priority Data
Jun. 12, 2007 (DE) 10 2007 027 044.7

(51) Int. Cl. C03B 5/18; C03B 5/16

(52) U.S. Cl. 65/134.5; 65/179

(57) ABSTRACT

A glass melting furnace with a tank and a superstructure with a furnace crown and a total internal length (“Lg”), with a preheating zone for charging material and a combustion zone with burners. A single radiation wall is located between the preheating zone and the combustion zone such that the length of the preheating zone is between 15 and 35% of the total internal length and the length of the combustion zone is between 65 and 85% of the total internal length. The preheating zone is designed for use solely with preheating of the charging material within the furnace. The oxidation gas supply contains at least 85 volume percent oxygen and at least one outlet for the waste gases from the preheating zone is connected to the atmosphere without a heat exchanger.

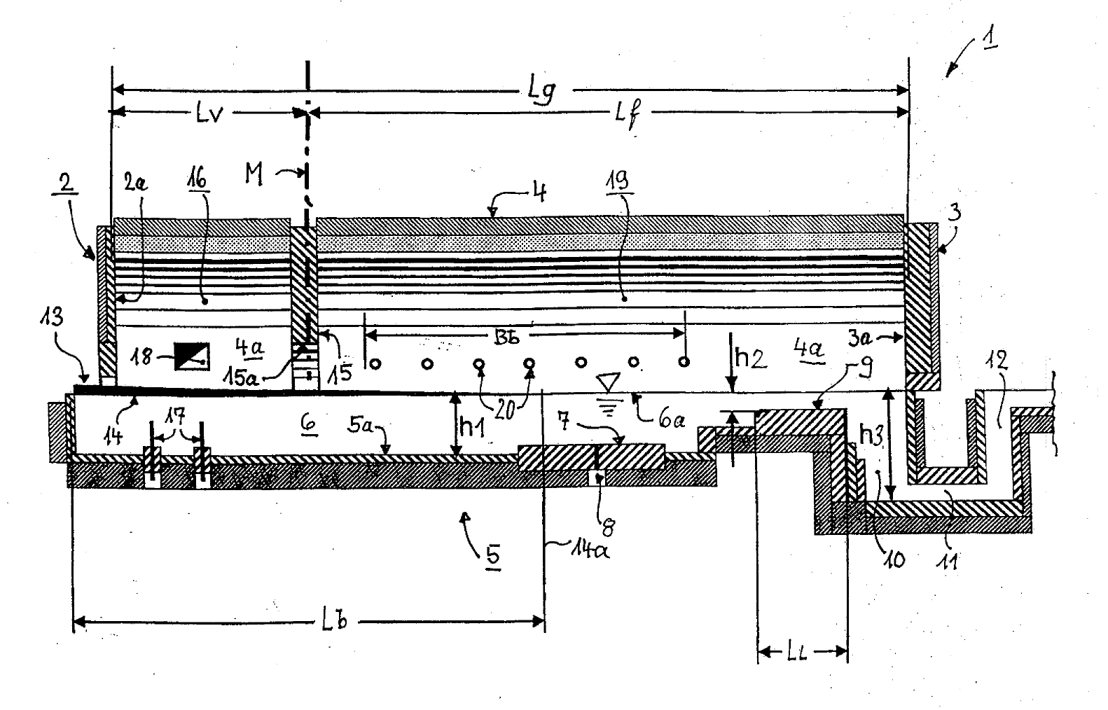

### BACKGROUND OF THE INVENTION

The invention relates to a glass melting furnace for melting glasses, in particular glasses from the group of soda-lime glasses, in particular container glass, or flat glass for rolling processes, and technical glasses, in particular borosilicate glass or neutral glass, having a tank and a furnace superstructure with a furnace crown and a total internal length (“Lg”), that together have a preheating zone for charging material with at least one outlet for waste gases, a combustion zone with burners, a raised part of the bottom, an homogenization zone, a bottom outlet and a vertical channel for the glass melt, whereby, the burners, in addition to a connection for fossil fuel, are equipped with a connection for a gas supply for oxygen-rich oxidizing gas, and whereby at least one row of bubblers is installed in the combustion zone in front of the raised part of the bottom.

The nearest state-of-the-art is considered to be contained in European patent 0 864 543 B1. This document contains a detailed description of the diametrically opposed problems that occur when glass is melted, such as poor heat transfer as a result of the poor thermal conductivity of the charging material and the glass melt, the difficult homogenization of the melt caused by its high viscosity, the risk of vaporization of volatile glass components as a result of long residence times on the flow paths, the unavoidable creation of oxides of nitrogen during the combustion of fossil fuels, and the reduction of the quantity of these oxides by increasing the oxygen content in the oxidation gas, the need for high temperatures in the furnace superstructure, the glass melt and the combustion gases, the resulting thermal and chemical stress on the mineral materials used in the furnace construction, and environmental pollution caused by pollutants in the waste gases, in particular from combinations of nitrogen and oxygen. On the one hand increasing the proportion of oxygen and decreasing the amount of nitrogen in the oxidation gas leads to a reduction in the formation of dangerous oxides of nitrogen, but on the other hand this also reduces the amount of combustion gases, so that with a given furnace volume the flow velocities and thereby the required heat transfer rates are reduced. The total furnace surface area is also a source of energy costs, either as a result of heat conduction or radiation or the cooling of critical components, whereby these costs vary according to the furnace size. This also applies to heated external equipment.

A solution to this problem was also seen in the avoidance of radiation walls in the superstructure, as are known from other examples of the state-of-the-art. The furnace type disclosed in the European patent 0 864 543 B1, known in the trade as the “Boro-Oxi-Melter”, has proven very successful over many years. However, legal requirements concerning the specific energy consumption and environmental pollution resulting from both energy consumption and waste gases have been drastically tightened, both for the energy suppliers and the furnace operation itself, so that the complex relationships mentioned above must be reconsidered.

There are not only economic reasons for developing glass melting furnace concepts that make use of the most up-to-date technical standards, based on existing experience and knowledge of heat utilization, heat transfer to the batch and heat losses from the complete installation. Current legal limits have already placed clear limitations on the permissible emissions of nitrogen oxides in the waste gases, and these limitations will be tightened further in future. Apart from the efficiency aspect, the emission of greenhouse gases is becoming more important, and the carbon dioxide resulting from the combustion of fossil fuels is a specific example of such gases. Furnace operators are provided with certificates to cover their allowable emissions of carbon dioxide, and if the actual emissions exceed the amount covered by the certificates the operator is penalized.

In the case of fossil fuel heated melting installations it is known that the efficiency is greatly improved if the heat can be recovered from the waste gases and used to preheat the combustion air. A high level of heat recovery produces high combustion temperatures. Adding air to the fuel results in a high flame temperature. This is one of the main causes of the formation of pollutant nitrogen oxides. It is known that much higher air preheat temperatures can be achieved with a regenerative system than with a recuperative system. However, the nitrogen oxide emissions are then also higher.

Nevertheless, in order to produce an efficient melting installation with recuperative heating, an installation was developed according to European patent 0 638 525 B1, this came to be known in the trade as the “LoNOx Melter”. The significant features of this technology are the special design of the combustion zone with two internal radiation walls, a heat recovery system for heating the combustion air in an external heat exchanger and a lack of bottom electrodes in the charging area. This produces a specific energy consumption that can be compared with a very efficient installation with regenerative heat recovery. However, this technology has disadvantages; not only is a heat exchanger required for the heat transfer to the combustion air, but the furnace must be very long and deep, and the design of the superstructure and crown is complicated. The furnace tank must be deep because the hot glass melt in the bottom area must be transported back to the charging area in order to compensate for the effect of the missing bottom electrodes in this area. The complex construction over the complete furnace length and the large surface area result in significantly higher heat losses to the environment that cannot be reduced by very much by the use of normal thermal insulation. Therefore the investment and operating costs for the complete installation are high.

As an alternative to this solution, but which only addresses the emission of nitrogen oxides, it is possible to heat the furnace with fossil fuels and almost pure oxygen or oxygen with a purity level of at least 90%. The values for nitrogen oxide emissions that can be achieved with this method, quoted as the mass flow of pollutants in relation to the amount of molten glass produced, are at a level that can be achieved with recuperative heat recovery. Another disadvantage of this solution is that the economics are not improved. It is known that the energy consumption can be lowered if a change to fossil fuel-oxygen heating is made. However the reduction achieved is not sufficient to compensate for the additional cost of oxygen production. Therefore the operating costs are still higher than those of an installation with gas-air heating and regenerative heat recovery. An important factor here is the heat content of the waste gases that leave the combustion zone. Normally the heat contained in these waste gases is not recovered, as the energy is returned directly to the furnace.

In order to take account of the partially contrary causes and effects, while adhering to and following the regulations concerning environmental pollution and energy wastage, and to improve the energy balance by recovering heat, proposals have often been made to use the excess heat present in the waste gases to preheat the solid components, i.e. the batch or charging materials, and the oxidation gases for the combustion, in an external heat exchanger before they enter the furnace.

External heat exchangers are expensive auxiliary items that require a great deal of maintenance, and also produce further heat losses, as there is no thermal insulation that can completely eliminate heat loss. In addition certain batch components may start to melt during this preheating, and stick to the surfaces of the heat exchanger, and when there is direct contact between the waste gases and the batch, not only do some components begin to melt, but segregation may occur and certain batch components can also be picked-up by the gases, and so the dust content of the waste gases may exceed permissible limits, or expensive dust filters must be installed in order to prevent this happening. The risk of sticking is also increased by water in the charging material that turns to steam, or water present in the combustion gases.

In a paper “Technical possibilities for using waste gases to heat batch and cullet” in the HVG-Mitteilung (=HVG-Newsletter) No. 1524 from August 1983, the author U. Trappe described, for example, that it is known that furnace waste gases can also be used in counterflow in spiral conveyors to preheat the charging material. However, in the summary it is stated clearly that when batch preheating is used there is also the risk of segregation, which can lead to a change in the batch composition.

U.S. Pat. No. 5,807,418 describes the use of an oxidation gas with an increased oxygen content in combination with the use of drawn-off combustion gases to preheat the charging material—the glass making raw materials—together with various gases such as air, oxygen and fossil fuels, using external preheaters, whereby a particularly small charging area is bounded by one radiation wall. This requires several circulating loops for the gases and a multitude of pipes. As there is no insulating material that allows no heat to pass through the additional pipework and the large volume heat exchanger it must result in an increase in the fuel consumption and heat losses to the environment, whereby a premature draw-off of combustion gases is equivalent to a source of losses for the combustion chamber.

### SUMMARY OF THE INVENTION

The object of the invention is therefore to provide a glass melting furnace and operating method in which the partially contrary causes and effects are unified without the use of an external heat exchanger, so that the batch components do not start to melt or stick to one another or to the surfaces of the heat exchanger, and segregation does not take place, while at the same time complying as far as possible with regulations concerning environmental pollution and energy wastage. The intention is also to achieve a reduction in the entrainment of certain batch components in the waste gases and in the dust content of the waste gases, which can also influence the glass quality. Furthermore, it is intended to utilise primary measures in the melting installation to reduce the emissions of nitrogen oxides, without detriment to the efficiency and without the necessity of providing additional operating systems, equipment or personnel.

This object is achieved according to the invention, by means of the glass melting furnace described above, in that:

a single radiation wall with a bottom edge is installed above the charging material between the preheating zone and the combustion zone, such that the length “Lv” of the preheating zone is limited to values from 15 to 35% of the total internal length “Lg” and the length “Lf” of the combustion zone extends over 65 to 85% of the total internal length “Lg”,

the preheating zone is designed solely for internal preheating of the charging material,

the gas supply for the oxidation gas has an oxygen content of at least 85 volume percent, and that

the at least one outlet for the waste gases in the preheating zone is connected directly to the atmosphere without a heat exchanger.

The object of the invention is therefore completely achieved by a glass melting furnace and operating method in which the partially contrary causes and effects are unified without the use of an external heat exchanger, so that the batch components do not start to melt or stick to one another or to the surfaces of the heat exchanger, and segregation does not take place, while at the same time complying as far as possible with regulations concerning environmental pollution and energy wastage. In addition there is a reduction in the entrainment of certain batch components and in the dust content of the waste gases, so that the influence on the glass quality is reduced. Furthermore, primary measures in the melting installation are used to reduce the emissions of nitrogen oxides, without detriment to the efficiency and without the necessity of providing additional operating systems, equipment or personnel. In particular, the specific energy consumption, based on a tonne of melted glass, is significantly reduced by the invention.

In connection with further embodiments of the invention it is particularly advantageous if—either individually or in combination—:

at least one row of electrodes is installed in the tank bottom of the preheating zone,

the bubblers near the end of the burner zone are installed before the raised part of the bottom,

the bubblers are installed in a retaining plate, the upper surface of which protrudes above the tank bottom,

the tank bottom is designed to slope downwards towards the raised part of the bottom,

the tank bottom is designed to slope upwards towards the raised part of the bottom,

the tank bottom is stepped,

the design glass bath depth “h2” above the raised part of the bottom amounts to between 25 and 50% of the design glass bath depth “h1” in the tank immediately before the raised part of the bottom,

the design glass bath depth “h3” in the homogenization zone behind the raised part of the bottom amounts to between 0.8 and 2.0 times the design glass bath depth “h1” immediately before the raised part of the bottom,

the burners are installed in a burner area “Bb” that ends before the raised part of the bottom,

a charging opening is located between the tank and the superstructure, and/or, if

the length “LL” of the raised part of the bottom in the direction of flow amounts to between 0.5 and 15% of the total internal length “Lg”.

The invention also relates to a method of melting glasses, in particular glasses from the group of soda-lime glasses, in particular container glass, or flat glass for rolling processes, and technical glasses, in particular borosilicate glass or neutral glass, from raw materials in a glass melting furnace with a total internal length “Lg”, a tank, a charging opening, a preheating zone and a combustion zone, whereby the unpreheated charging material is introduced through the charging opening onto the glass melt, and is heated within the preheating zone, which has a length “Lv” that is between 15 and 35% of the total length “Lg” and is terminated by a single radiation wall, whereby the charging material is

heated from above by the combustion gases and bubbler gases from the combustion zone which pass underneath the radiation wall and into the preheating zone and leave the preheating zone through at least one outlet, and

heated from below by that part of the glass melt that is transported upwards by the action of the bubblers and then is returned immediately below the charging material in the direction of the charging opening,

whereby burners in the combustion zone produce the combustion gases from fossil fuel and an oxidation gas that contains at least 85% oxygen, whereby the combustion zone on the other side of the radiation wall has a length “Lf” that amounts to between 65 and 85% of the total internal length “Lg”, and whereby the glass melt flows first over a row of bubblers and then over a raised part of the bottom into a homogenization zone.

It is particularly advantageous, if—either individually or in combination—

when necessary the glass melt is heated from below by electrodes, and/or, if

the glass melt is transported over the raised part of the bottom along a length that amounts to between 0.5 and 15% of the total internal length “Lg”.

The effect of the double heating of the charging material from above and below is explained as follows: On the one hand the combustion with an oxidation gas with an increased oxygen content compared with air produces higher flame temperatures, while on the other hand, the specific waste gas quantities and, if the combustion chamber dimensions remain unchanged, the flow velocities are reduced. This leads to the situation in which the heat transfer in the region of the combustion, or in other words the radiating flames, is relatively high whereas in those areas away from the flames, and here in the batch charging area, a lower rate of heat transfer is found. This is the reason for the proposals already known—for example in U.S. Pat. No. 5,807,418—which suggest the use of external heat exchangers to preheat charging material and gases. The subject of this invention goes in a different and more advantageous direction involving the use of bubblers and bubbler gases. The bubbler gas produces a strong rising current in the glass bath above each entry location, whereby the return current that moves below the charging material towards the charging end of the furnace is strengthened and the melting effect from below is increased. At the same time during its rise the bubbler gas is raised more or less to the temperature of the glass melt, which is normally at its highest at this location. Then, the bubbler gas is pulled into and mixed with the combustion gases, such that the gas quantity and the flow velocity of this mixture over the charging material in the direction of the charging end of the furnace are increased, as is the melting effect from above. This extremely efficient heat transfer takes place entirely within the furnace and therefore over a short distance, and therefore improves the heat balance, reduces the building, operating and maintenance costs and decreases the susceptibility to disturbance of the complete glass melting unit. The low concentration of nitrogen oxides is retained.

### BRIEF DESCRIPTION OF THE DRAWING

An example of the invention and the method used, and further advantages are detailed below on the basis of the only FIGURE. The FIGURE shows a vertical longitudinal section along the main glass melting furnace axis.

### DETAILED DESCRIPTION OF THE PREFERRED EMBODIMENTS

At the charging end of a superstructure 1 there is a first end wall 2 and at the extraction end there is a second end wall 3, and an arched furnace crown 4 extends between these two walls. The furnace crown 4 merges on both sides into vertical side walls 4a, of which only the rear wall is visible here. Below the superstructure 1 there is a tank 5, which is designed to hold and process a glass melt 6, the surface of which is indicated at location 6a. The tank 5 has a tank bottom 5a, from which a retaining plate 7 with a row of bubblers 8 protrudes upwards. Thereafter the tank bottom 5a is stepped up to the raised part of the bottom 9, and after this raised part of the bottom 9 there follows a homogenization zone 10, a bottom outlet 11 and a vertical channel 12.

A charging opening 13 is located below the bottom edge of the end wall 2 and above the melt surface 6a and this charging opening 13 can extend across the complete width of the tank 5. The charging material 14, introduced in this case without being externally preheated, is indicated by a thin black wedge that ends on the line 14a. The length of this zone inside the furnace is referred to as the charging length Lb.

The design and location of a single vertical radiation wall 15 are particularly important. The radiation wall 15, which may have an arched bottom surface 15a, extends downwards from the furnace crown 4 and ends above the charging material 14. The distance of the apex of the bottom surface 15a can be chosen at between 500 and 1500 mm depending on the size of the furnace. In order to simplify the description, the radiation wall 15 is shown with an imaginary vertical central plane M. The total internal length Lg of the furnace may be as much as 25 m, the internal width as much as 10 m, but these values are not critical limits.

Bubbler gas rises from the bubblers 8 as a row of bubbles, which results in a strong upward current in the glass melt 6, and, in particular, produces a strong return current of part of the glass melt 6 immediately beneath the glass melt surface 6a and the charging material 14 in the direction of the charging opening 13. After leaving the glass melt 6 the strongly heated bubbler gases are pulled into and mixed with the combustion gases, and intensify the heating effect of the combustion gases on the glass melt 6 and on the top surface of the charging material 14, as was described above.

It is important here that the radiation wall 15, represented by its central plane M, is at a distance Lv from the inside surface 2a of the end wall 2, whereby the distance Lv is between 15 and 35% of the total internal length Lg. This creates a preheating zone 16 that is relatively short in comparison with the state-of-the-art. In addition electrodes 17 can be installed in the glass melt 6 in this preheating zone 16, whereby these electrodes can be installed vertically in at least one row in the tank bottom 5a, perpendicular to the longitudinal axis of the furnace, as shown in the drawing, or as an alternative, horizontally in the side walls of the tank 5. In the preheating zone 16 there is also at least one outlet 18, installed in at least one of the side walls 4a, for the combustion and bubbler gases that flow below the radiation wall 15. Therefore within a relatively short distance, the equivalent of Lv, sufficient heat quantity can be passed to the charging material 14 from above and below, so improving the heat balance.

The radiation wall 15 and the inside surface 3a of the second end wall 3 are at a distance Lf apart, and this space encompasses the combustion zone 19. This is marked by two rows of burners 20 that are installed in the opposite walls 4a of the superstructure 1 and that are distributed equidistantly within a burner zone Bb. As a result of the effect of the burners 20 and the radiation from the wall surfaces of the combustion zone 19 the charging material 14 and the glass melt 6 are heated up, until the melting temperature reaches a certain maximum value above the raised part of the bottom 9. The combustion gases flow from the combustion zone 19 under the radiation wall 15 into the preheating zone 16 and from here through the at least one outlet 18 into at least one stack, which is not shown here. In continuation of the length calculation detailed above it can be seen that the distance Lf amounts to between 65 and 85% of the total internal length Lg. For practical purposes the ratio of the length LL of the raised part of the bottom to the total length Lg is chosen to be between 0.5 and 15%.

As an example seven burners 20 are located on either side of the combustion zone 19 within the burner zone Bb, whereby the burner zone Bb ends before the raised part of the bottom 9, as sufficient radiant heat is available above this.

As a result of the vertical transport action of the bubblers 8 and where applicable electrodes 17 a return glass flow in the direction of the electrodes 17 is created on the surface of the glass melt 6 and an opposing bottom current is created from the electrodes 17 in the direction of the bubblers 8. This flow effect increases the transfer of heat, in particular from the glass melt 6 to the charging material 14, as already described above.

With reference to the glass bath depths: h1 is the glass bath depth above the tank bottom 5a. The glass bath depth h1 can change along the length of the tank, according to whether the tank bottom rises or falls in the direction of the raised part of the bottom, whereby any rise or fall in the tank bottom may also be stepped.

It is advantageous if the glass bath depth h2 of the glass melt over the raised part of the bottom 9 amounts to between 25 and 50% of h1 immediately before the raised part of the bottom 9. The maximum glass bath depth in the preheating zone 16 is as much as the glass bath depth immediately before the raised part of the bottom, whereby the ratio can lie between 80 and 100%. It is advantageous if the value chosen for the glass bath depth h3 in the homogenization zone 10 after the raised part of the bottom 9 is between 0.8 and 2 times the value for h1 immediately before the raised part of the bottom 9.

The gist of the invention relates to a glass melting furnace with a tank 5 and a superstructure 1 with a furnace crown 4, and a total internal length “Lg”, with a preheating zone 16 for charging material 14 and with a combustion zone 19 with burners 20 and bubblers 8. In order to achieve the aim according to the invention it is proposed that a) a single radiation wall 15 is installed between the preheating zone 16 and the combustion zone 19, such that this radiation wall limits the length “Lv” of the preheating zone 16 to between 15 and 35% of the total internal length “Lg”, so that the length “Lf” of the combustion zone 19 lies between 65 and 85% of the total internal length “Lg”, b) the preheating zone 16 is designed so that the charging material 14 is preheated solely within the furnace, c) a gas supply for the oxidation gas has an oxygen content of at least 85 volume percent oxygen, and that d) in the preheating zone 16 at least one outlet 18 for the waste gases is connected to the atmosphere without a heat exchanger.

From the above description, it is apparent that the objects of the present invention have been achieved. While only certain embodiments have been set forth, alternative embodiments and various modifications will be apparent from the above description to those skilled in the art. These and other alternatives are considered equivalents and within the spirit of scope of the present invention. It should be understood that I wish to embody within the scope of the patent warranted heron all such modifications as reasonably and properly come within the scope of my contribution to the art.

1-15. (canceled)

16. A glass melting furnace for melting glasses into a glass melt having a tank and a superstructure with a furnace crown and a total internal length, that together have, in a direction of flow of the glass melt, a preheating zone for charging material with at least one outlet for waste gases, a combustion zone with burners, a raised part of a bottom of the tank that extends across a complete width of the tank, a homogenization zone, a bottom outlet and a vertical channel for the glass melt, whereby, the burners, in addition to a connection for combustible fuels, are equipped with a connection for a gas supply for oxygen-rich oxidizing gas, and whereby at least one row of bubblers is installed in the combustion zone in front of the raised part of the bottom, comprising:
a single radiation wall with a bottom surface positioned above the charging material between the preheating zone and the combustion zone to limit a length of the preheating zone to a value between 15 to 35% of the total internal length so that a length of the combustion zone lies between 65 and 85% of the total length,
the preheating zone being free of any preheating apparatus external of the charging material,
the gas supply for the oxidizing gas having an oxygen content of at least 85 volume percent oxygen, and
at least one outlet for waste gases in the preheating zone being connected to an external atmosphere without a heat exchanger.

17. A glass melting furnace according to claim 16, wherein at least one row of electrodes is installed in a tank bottom of the preheating zone.

18. A glass melting furnace according to claim 16, wherein the bubblers are installed in front of the raised part of the bottom near an end of the burner zone.

19. A glass melting furnace according to claim 18, wherein the bubblers are installed in a retaining plate, a top surface of which projects upwards above the tank bottom.

20. A glass melting furnace according to claim 16, wherein the tank bottom slopes downwards towards the raised part of the bottom.

21. A glass melting furnace according to claim 16, wherein the tank bottom slopes upwards towards the raised part of the bottom.

22. A glass melting furnace according to claim 20, wherein the tank bottom is stepped.

23. A glass melting furnace according to claim 16, wherein a designed glass bath depth of the glass above the raised part of the bottom amounts to between 25 and 50% of a designed glass bath depth in the tank directly in front of the raised part of the bottom.

24. A glass melting furnace according to claim 16, wherein in the homogenization zone following the raised part of the bottom a designed glass bath depth is 0.8 to 2.0 times greater than a designed glass bath depth immediately in front of the raised part of the bottom.

25. A glass melting furnace according to claim 16, wherein the burners are installed in a burner zone, that ends prior to the raised part of the bottom.

26. A glass melting furnace according to claim 16, wherein a charging opening is located between the tank and the superstructure.

27. A glass melting furnace according to claim 16, wherein a length of the raised part of the bottom in the direction of flow amounts to between 0.5 and 15% of the total internal length.

28. A method for the melting of glasses into a glass melt from charging material in a glass melting furnace with a total internal length, and having a tank with a bottom, a charging opening communicating with the tank, a preheating zone and a combustion zone separated by a single radiation wall, with bubblers operating in the combustion zone, comprising the steps:
introducing unpreheated charging material through the charging opening and onto the glass melt,
heating the charging material within the preheating zone which has a length that is between 15 and 35% of the total length and is terminated by the single radiation wall,
heating the charging material from above by combustion gases and bubbler gases from the combustion zone that flow back under the radiation wall into the preheating zone, as the charging material moves through the preheating zone, and through at least one outlet,
heating the charging material from below by that part of the glass melt that is transported upwards by the bubblers and then transported back immediately underneath the charging material in the direction of the charging opening,
operating burners in the combustion zone to produce combustion gases in the combustion zone from combustible fuels and an oxidation gas that contains at least 85% oxygen, and
flowing the glass melt through the combustion zone which has a length that amounts to between 65 and 85% of the total internal length by flowing the glass melt first over a row of bubblers and then over a raised part of the bottom into a homogenization zone.

29. A method according to claim 28, further including the step of heating the glass melt from below by electrodes.

30. A method according to claim 28, wherein the step of flowing the glass melt over the raised part of the bottom occurs for a distance of between 0.5 and 15% of the total internal length.
